(19) United States
(12) Patent Application Publication
(10) Pub. No.: US 2022/0243065 A1
(43) Pub. Date: Aug. 4, 2022

(54) FILAMENT FOR 3-D PRINTING OF CHEWABLE DOG TOYS AND TREATS

(71) Applicant: Joel Mendelsberg, Renton, WA (US)

(72) Inventor: Joel Mendelsberg, Renton, WA (US)

(21) Appl. No.: 17/162,752

(22) Filed: Jan. 29, 2021

(51) Int. Cl. C08L 89/00; C08L 67/04; C08L 1/02; A23K 20/147; A23K 20/105; A23K 20/163; A23K 50/40; A23P 20/20; A23K 40/25; B33Y 10/00; B33Y 40/10; B33Y 70/00; B29C 64/118; B29C 64/314; A01K 15/02

(52) U.S. Cl. CPC C08L 89/00; A23P 2020/253; C08L 1/02; A23K 20/147; A23K 20/105; A23K 20/163; A23K 50/40; A23P 20/20; A23K 40/25; B33Y 10/00; B33Y 40/10; B33Y 70/00; B29C 64/118; B29C 64/314; A01K 15/026; C08L 67/04

(57) ABSTRACT

A filament for 3-D printing of chewable toys and treats suitable for dogs and other domestic animals is made by preparing a mixture of plasticized thermoplastic with reinforcement agent, lubricating agent and preservative and then extruding the prepared mixture to form a filament. Embodiments may further include aroma enhancers, flavoring additives and nutritional additives in the mixture, alone or in combination.

### BACKGROUND OF THE INVENTION

### Field of the Invention

This invention is related to filaments for 3-D printing. More specifically, this invention is directed to filaments suitable for 3-D printing of chewable dog toys and dog treats.

### Description of the Related Art

Many domestic animals, referred to here for simplicity but not by way of limitation as dogs, have a need or desire to chew on various objects. Chewable dog toys are fabricated to meet this need. Such chewable toys have a number of essential characteristics. They should present chewable surfaces of dimension appropriate for the animal in question. It is desirable that toys present an attractive form for the animal, encouraging beneficial chewing and play. They should be comprised of a material that is non-toxic, possessing sufficient strength and durability as not to fragment into small pieces posing a health risk if eaten by the dog. They should resist the proliferation of infectious or spoilage organisms despite frequent mastication.

Treats are simply morsels that are pleasurable or reinforcing when eaten by the animal. Treats at the very least should be non-toxic and preferably be easy for the animal to digest. It is preferable also that a pet treat be easy for the animal's human handler to manage, enabling the handler to dispense a treat conveniently as needed or appropriate. Sticky, oily or malodorous treats are disfavored. For storage, treats preferably should have a reasonable shelf life.

There are a number of additional characteristics that are required or desirable for dog toys and treats. It is required for treats and desirable in embodiments of dog toys that a favorable flavor is presented for the dog. It is further desirable that embodiments provide some nutritional benefit. It is further desirable that agents providing such characteristics be incorporated integrally in the treat or toy, so that the desirable characteristics not attenuate in use.

Related art has endeavored to produce chewable items carrying various beneficial agents. Typical of such items directed to dental appliance technologies is U.S. Pat. No. 7,328,706 B23 to Bardach et al., for a dental therapeutic device as an intra-oral delivery system for agents including flavoring compositions, nutraceuticals and other medications and chemotherapeutics. The agents, however, are not integral to the device, which instead relies on inserts placed within it to provide the required agents intra-orally to the subject.

U.S. Pat. No. 10,780,085 B2 to Gao et al., describes an oral product that can provide intra-oral delivery of drugs such as nicotine in combination with flavoring agents. Gao's product comprises a mouth-stable polymer matrix, cellulose fibers embedded in the matrix and a mouth-stable binder dispersed in the polymer matrix. This invention is unsuitable for chewable dog toys in large part because the cellulose fiber component is not of sufficient durability to last long under canine mastication.

In U.S. Pat. No. 10,463,578 B2, Evans et al. describe a flavor or scent carrying pacifier or teething ring. While some embodiments provide an integral antimicrobial agent in the composition of the device, Evans et al. describe flavoring agents that are deposited on the exterior of the intra-oral portion of the device and do not contemplate integral flavoring materials. Further, this device, fabricated for human infants, does not provide the durability needed for a chewable dog toy, nor, in its intended use, does it provide an ingestible morsel that serves as a treat.

In a different area of technology, 3-D printing of articles by way of fused filament fabrication or FDM® (fused deposition modeling) has become commonplace, not only as an industrial production technology but also, with the advent of relatively inexpensive 3-D printer consumer appliances, as a process for fabricating desired articles with custom configurations at home. Such technology typically uses a thermoplastic composition, often in the form of a strand or filament, that is heated past its glass transition temperature to liquefaction and then extruded and deposited in precisely shaped layers under servo control, each successive layer fusing with previous layers to form the article with the desired configuration. It is desirable that there be a process and filament composition suitable for manufacture of dog toys by fused deposition technology. It is particularly desirable that users be able to employ a 3-D printer to create chewable dog toys or treats at home.

Prior art materials for 3-D printing are inadequate to create chewable dog toys or treats with essential characteristics and do not provide many other characteristics that are desirable in such articles. In U.S. Pat. No. 9,523,160 B1, Kim et al. describe a filament for 3-D printing that contains an antimicrobial agent. Kim's filament, however, is not suitable for 3-D printed dog toys because it does not provide articles with sufficient tensile and shearing strength to resist fragmentation in typical use by dogs. Further, Kim's filament does not provide a reinforcing flavor or odor required for dog treats.

What is needed is a composition and method of preparing a filament for 3-D printing of chewable dog toys and treats having essential and desirable characteristics.

### SUMMARY OF THE INVENTION

A filament for 3-D printing of chewable toys and treats suitable for dogs and other domestic animals is made by preparing a mixture of plasticized thermoplastic with reinforcement agent, lubricating agent and preservative and then extruding the prepared mixture to form a filament. Embodiments may further include aroma enhancers, flavoring additives and nutritional additives in the mixture, alone or in combination. Embodiments may prepare the mixture by first drying the mixture prior to extrusion. Additionally, embodiments may prepare the mixture by pelletizing prior to filament extrusion. In some such embodiments, additional plasticized thermoplastic is added to the pelletized mixture prior to extrusion as filament.

### BRIEF DESCRIPTION OF THE DRAWINGS

Objects of the present invention as well as advantages, features and characteristics, in addition to the combination of its constituents and their relative amounts and methods and economies of manufacture will become apparent upon consideration of the following description and claims with reference to the accompanying drawings, all of which form a part of this specification, wherein like reference numerals designate corresponding parts in the various figures, and wherein:

FIG. 1. is a chart illustrating general constituents of and steps for manufacturing an embodiment of a filament for chewable dog toys or treats;

FIG. 2 illustrates the steps in an embodiment for producing the filament from the mixture;

FIG. 3 is a table of values pertaining to Example 3 below;

FIG. 4 is a table of values pertaining to Example 4 below;

FIG. 5 is a table of values pertaining to Example 5 below; and

FIG. 6 is a table of values pertaining to Example 6 below.

### DETAILED DESCRIPTION OF THE INVENTION

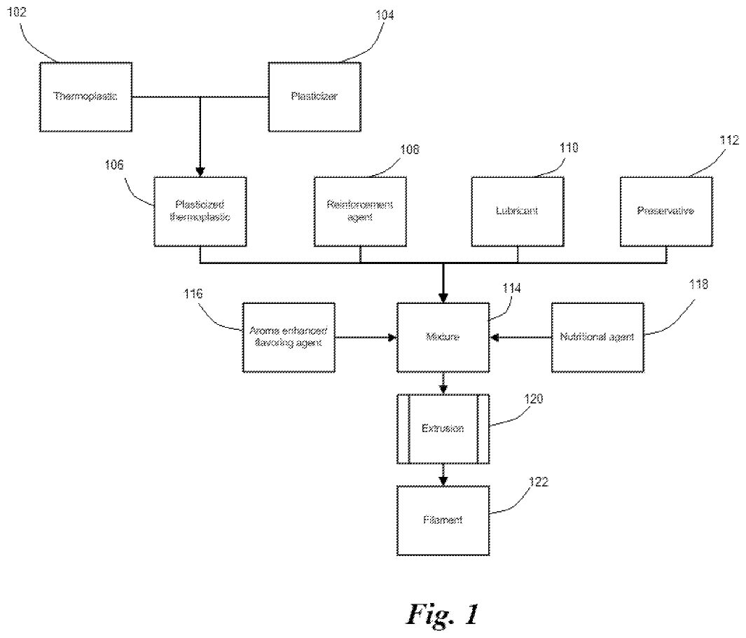

Embodiments of the invention prepare a mixture of thermoplastic with other components that can be extruded to form a filament suitable for 3-D printing of chewable dog toys or treats. Turning now to the drawings, FIG. 1 shows the general constituents of and steps for manufacturing an embodiment of such a filament. The principal component of the filament of this invention is thermoplastic 102.

While a variety of polymers are suitable for thermoplastic 102, it is essential that thermoplastic 102 be biodegradable and have low toxicity when used in a chewable dog toy or treat. Embodiments of the present invention may employ plant-based protein for thermoplastic 102, such as soy protein isolate sold as ProFam®974 by Archer Daniels Midland of Chicago, Ill. Alternatively, embodiments may use polylactic acid (PLA) such as Ingeo™ Biopolymer 4032 from NatureWorks LLC of Wazata, Minn. or H25CPLA3 from The Hemp Plastic Company of Boulder, Colo. As will be appreciated by those in the art, thermoplastic 102 selected for embodiments of invention must also be such that, in combination with other components of the composition, it will result in a filament that is easy to extrude in 3D printing and will produce articles with the required physical characteristics.

Thermoplastic 102 is plasticized with plasticizer 104. Plasticizer 104 is selected based on the physical and chemical requirements for the particular thermoplastic 102 used in the composition. The purpose of the plasticizer is to condition the thermoplastic to increase its plasticity, serving two principal purposes. First, increased plasticity of the thermoplastic renders it more suitable for the thermal extrusion involved in filament production. Second, plasticizing is needed so that the finished product that is 3-D printed from the filament has the requisite physical characteristics. A wide variety of substances may be used for plasticizing thermoplastic 102. In any case, however, just as for thermoplastic 102 it is essential that plasticizer 104 be non-toxic as a component fabricated into a chewable dog toy or treat.

The plasticizer 104 that is used and the relative proportion required of thermoplastic 102 to plasticizer 104 depends upon the specific materials employed and the desired physical characteristics of the intended finished 3-D printed products. Suitable substances for plasticizing thermoplastic 102 for embodiments of the invention include water, glycerol, polypropylene glycol and soybean oil, in varying proportions. By way of example, in an embodiment using soy protein isolate as thermoplastic 102, acceptable plasticizing for filament for a dog treat is achieved by using 70 to 80 parts by weight of water as plasticizer 104 to 100 parts of soy protein. In an alternative embodiment still using soy protein isolate, 5 to 10 parts by weight of glycerol as plasticizer 104 serve to plasticize 100 parts by weight of thermoplastic 102.

To maintain the integrity of the composition on extrusion and to produce articles of requisite strength and durability, a reinforcement agent 108 is added to the plasticized thermoplastic 106 Suitable reinforcement agents include plant fibers such as hemp fiber from Assocanapa SRL of Carmagnola, Italy, or bran fiber, widely available as animal feed. Other reinforcement agents include cellulose products such as C083 cellulose fiber from Millipore Sigma (formerly Sigma-Aldritch) of St. Louis, Mo. or Celova® microfibrilated cellulose powder from Weidmann Fiber Technology of Rapperswil, Switzerland.

The proportion of reinforcement agent 108 required to provide the requisite integrity, strength and durability in a resultant plastic composition varies with the type of thermoplastic 102 and the chemical and physical characteristics of reinforcement agent 108. As a rule, integrity, strength and durability increase with increasing ratios of a given reinforcement agent 108 to thermoplastic 102. Also as a rule, for a given reinforcement agent, these values are lower for reinforcement agent in particulate form and higher for fibrous forms, increasing with increasing average reinforcement agent fiber length.

The selection and proportions of thermoplastic, plasticizer and reinforcement agents for a filament according to embodiments of the invention is determined by the required physical characteristics of the finished 3-D printed articles that the filament is intended to produce. In the case of a 3-D printed dog toy, the finished product must be durable and relatively rigid. Filaments comprised of plasticized PLA reinforced with plant fiber can provide the requisite mechanical properties needed for such finished articles.

### EXAMPLE 1

Table 1 below shows a range of tensile strength under testing standard ASTM D638 of an exemplary extruded composition having plasticized PLA reinforced with 5-10% hemp fiber. The relatively high tensile strength and moderate plasticity of the composition is suitable for a chewable dog toy.

TABLE 1

| Mechanical property | Value |
|---|---|
| Tensile strength (mPa) | 40-60 |
| Young modulus (mPa) | 3000-3200 |
| Elongation at break (%) | 2.5-5.0 |

On 3-D printing using a specific exemplary embodiment of the filament for chewable dog toys employing plasticized PLA with 9% reinforcing cellulose fibers, finished products were obtained with mechanical properties of 50 mPa of tensile strength, 3000 mPa of young modulus and 5% of elongation at break, acceptable values for a rugged durable dog chew toy.

In contrast, for a 3-D printed dog treat, the finished product must be chewable and ultimately consumable by the dog Soy protein isolate plasticized with water and glycerin and reinforced with cellulose nanoparticles provides a thermoplastic with the mechanical properties needed for this article.

### EXAMPLE 2

Table 2 below shows a range of tensile strength under testing standard ASTM D638 of exemplary extruded compositions of plasticized soy protein isolate reinforced with cellulose nanoparticles at 5-10%. The lower tensile strength and higher plasticity of the composition results in a filament that is more suitable for 3-D printing of an edible dog treat.

TABLE 2

| Mechanical property | Value |
|---|---|
| Tensile strength (mPa) | 15-20 |
| Young modulus (mPa) | 1500-2000 |
| Elongation at break (%) | 3.0-5.0 |

Using a specific exemplary embodiment of filament for 3-D printing of edible dog treats comprising soy protein isolate plasticized with 35% water and 5% glycerol and reinforced with 8% cellulose nanoparticles, finished products were obtained with the mechanical properties of 15 mPa of tensile strength, 1500 mPa of young modulus and 3% of elongation, suitable for articles that can be masticated and consumed by the animal.

To improve the workability of the material and thereby facilitate extrusion, lubricant 110 is added to the mixture. The inclusion of an adequate amount of lubricant also results in filament with smoother surface. Typical lubricants include zinc, calcium or magnesium stearate.

Preservative 112 is added to the mixture to prolong the life of the 3-D printed article. In the case of chewable dog toys, some preservatives serve to resist the proliferation of infectious or spoilage organisms despite frequent mastication. Preservatives appropriate for incorporation in dog treats and chewable dog toys include food preservatives derived from natural sources such as ascorbate, potassium sorbate or alpha-tocopherol, synthesized preservatives such as calcium propionate, and artificial preservatives such as BHA and BHT.

For chewable dog toys, it may be desirable to add antioxidants to preserve color and viscosity in the article by slowing polymer degradation. As will be understood by those in the art, a number of commonly used antioxidant stabilizers may be used for this purpose, including tris(2,4-di-tert-butylphenyl) phosphite or Pentaerythritol tetrakis(3,5-di-tert-butyl-4-hydroxyhydrocinnamate) and the many other plastics stabilizers provided by suppliers such as Chempoint.com, Inc. of Downers Grove, Ill.

Mixture 114 is prepared incorporating plasticized thermoplastic 106, reinforcement agent 108, lubricant 110 and preservative 112. To make filament for dog treats or chewable toys, additional components are added to the mixture. In particular, aroma enhancer/flavoring agent 116 may be added to the mixture as required for treats and desirable in embodiments of dog toys. Further, nutritional agent 118 may be an additional desirable component in embodiments of the invention.

Aroma enhancer/flavoring agent 116 is selected for some embodiments to result in a finished 3-D printed article that is favorable to the dog. A wide variety of such agents are available, among them the pet and animal flavoring products of Gold Coast Ingredients, Inc. of Commerce, Calif. The amount of aroma enhancer/flavoring agent 116 incorporated in mixture 114 is determined by amount of the chosen agent needed to produce evidence of the desired sensory effect in the finished article.

Nutritional agent 118, incorporated in some embodiments, may be a mineral supplement such as calcium carbonate or tricalcium phosphate, or a supplement such as glucosamine HCL or chondroitin sulfate to benefit joints, or antioxidants such as coenzyme Q10 or vitamin E, or other additives widely believed to have positive health effects, such as brewer's yeast, astaxanthin, spirulina, hawthorn berry extract or n-acetyl cysteine.

Mixture 114, comprising plasticized thermoplastic 106, reinforcement agent 108, lubricant 110, preservative 112, and at least one of aroma enhancer/flavoring agent 116 and nutritional agent 118, is extruded 120 to produce filament 122 for 3-D printing.

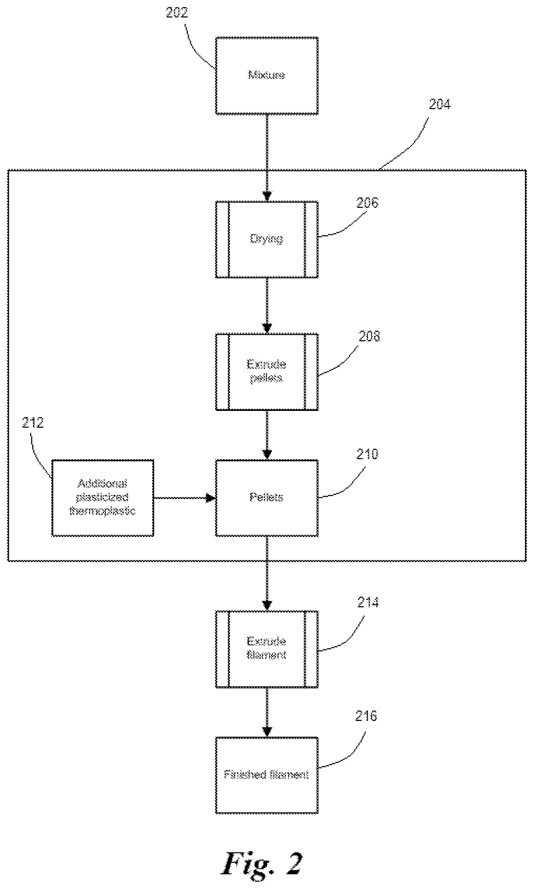

FIG. 2 illustrates an embodiment of a process for making a filament for dog toys or treats. Components are combined to form a mixture 202, such as described in reference to FIG. 1 above. In this embodiment, mixture 202 is subject to preparation 204 for extrusion 214 as finished filament 216. Because the constituent thermoplastic is typically hygroscopic and extrusion of wet thermoplastic results in articles with dimensional flaws, and in order to avoid extensive oxidation and hydrolyzation of the thermoplastic polymer links, preparation 204 of mixture 202 first entails drying 206. Drying 206 typically requires heating the mixture to temperature that is elevated but below the thermoplastic glass liquefaction temperature while providing air circulation for a period of time to reduce the moisture content of mixture 202 below 10%, preferably below 1%.

In the depicted embodiment, preparation 204 further involves a step 208 wherein the dried mixture is extruded as pellets, often referred to as nurdles. In a typical fabrication process, the extracted pellets contain no coloring material. Coloring may be added by adding colored thermoplastic 212, also typically in nurdle form, to the extracted pellets. The prepared pellet mixture 210 may then be extruded 214 to form finished filament 216.

Typical filament production involves mixing thermoplastic filament ingredients and then employing machinery to force the thermoplastic mixture through a barrel that is heated to a temperature above the glass liquefaction temperature for the mixture to be extruded. Mechanical properties of the filament depend not only on the composition of the mixture used for filament material but also on the manner in which components of the mixture are combined prior to extrusion as filament as well as on variables in the filament extrusion process.

The following examples illustrate the effects of varying a number of composition and production parameters on mechanical properties of filament in trials of embodiments of the present invention.

### EXAMPLE 3

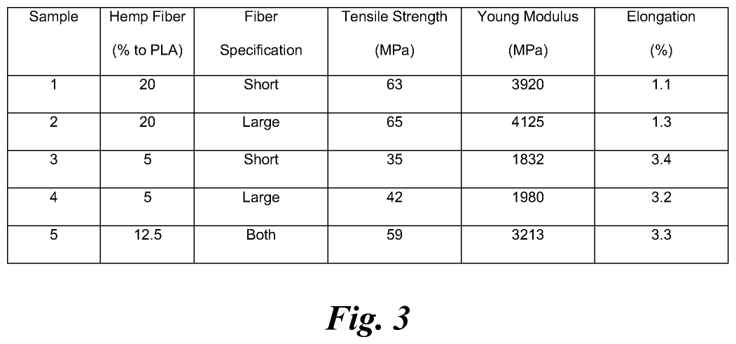

In this example the effect of the amount of reinforcing fibers and length on the mechanical properties of filament were tested. Filament ingredients were pre-mixed using a high-speed mixer at room temperature using a mixer speed of 2000 rpm. The ingredient quantity is as follows: 100 g of Polylactic acid (PLA4043D, Nature works), 2 g of brewer's yeast, 1 g of calcium stearate, 0.2 g of natural preservatives. Then the mixed ingredients were added to the hopper of an extrusion equipment having different temperatures throughout the barrel. The temperature profile used was 185° C., 195° C., 205° C., 205° C., 195° C., and screw speed was 20 rpm. All filaments were processed using a 3-D printing machine using the following conditions: Melting temperature: 215° C., Extrusion speed: 25 mm/s, molding speed: 30 mm/s, orifice size 0.4 and layer thickness 0.2 mm. The final design used for the mechanical properties testing of the filament were performed according to ASTM D638. The results are shown in FIG. 3.

### EXAMPLE 4

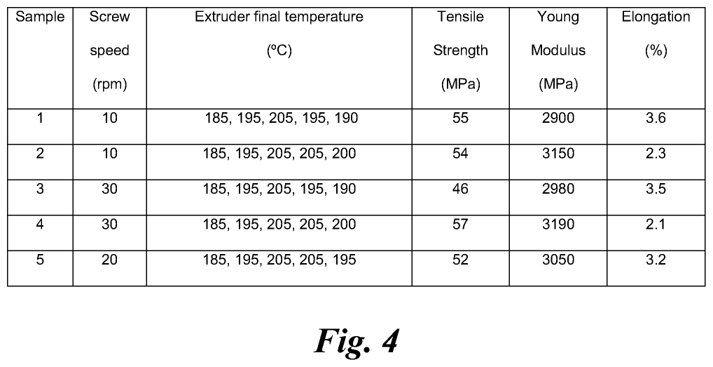

In this example the effect of the temperature profile and screw speed on the mechanical properties of the filament were tested. Filament ingredients were pre-mixed using a high-speed mixer at room temperature using a mixer speed of 2000 rpm. The ingredient quantity is as follows: 100 g of Polylactic acid (PLA4043D, Nature works), 10 g of hemp fibers, 2 g of brewer's yeast, 1 g of calcium stearate, 0.2 g of natural preservatives. Then the mixed ingredients were added to the hopper of an extrusion equipment having different temperatures throughout the barrel. All filaments were processed using a 3-D printing machine using the following conditions: Melting temperature: 215° C., Extrusion speed: 25 mm/s, molding speed: 30 mm/s, orifice size 0.4 and layer thickness 0.2 mm. The final design used for the mechanical properties testing of the filament were performed according to ASTM D638. The results are presented in FIG. 4.

### EXAMPLE 5

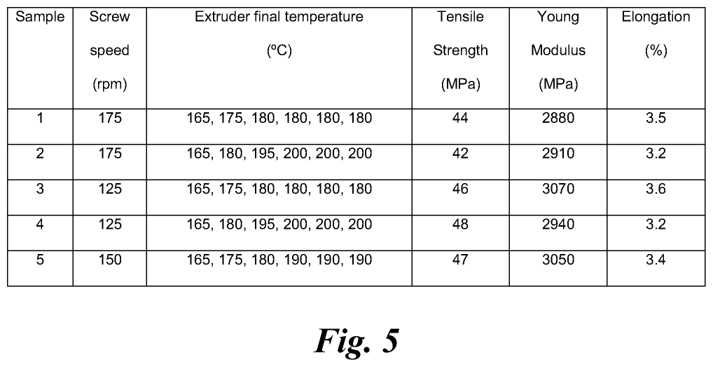

In this example the effect on the mechanical properties of the filament by mixing the components using an extruder rather than a high shear mixing chamber was tested. Filament ingredients were added to the hopper of a twin-screw extrusion equipment. The ingredient quantity is as follows: 100 g of Polylactic acid (PLA4043D, Nature works), 10 g of hemp fibers, 2 g of brewer's yeast, 1 g of calcium stearate, 0.2 g of natural preservatives. Then the pellets of mixed ingredients were added to the hopper of an single screw extrusion equipment having different temperatures throughout the barrel. The temperature profile used was 185° C., 195° C., 205° C., 205° C., 195° C., and screw speed was 20 rpm. All filaments were processed using a 3d printing machine using the following conditions: Melting temperature: 215° C., Extrusion speed: 25 mm/s, molding speed: 30 mm/s, orifice size 0.4 and layer thickness 0.2 mm. The final design used for the mechanical properties testing of the filament were performed according to ASTM D638. The results are shown in FIG. 5.

The mechanical properties of 3-D printed articles, in turn, depend on the composition of the filament and the specifics of the 3-D printing process used. The following examples illustrate the effects of varying a number of composition and production parameters on mechanical properties of 3-D printed articles in trials of filament in embodiments of the present invention.

### EXAMPLE 6

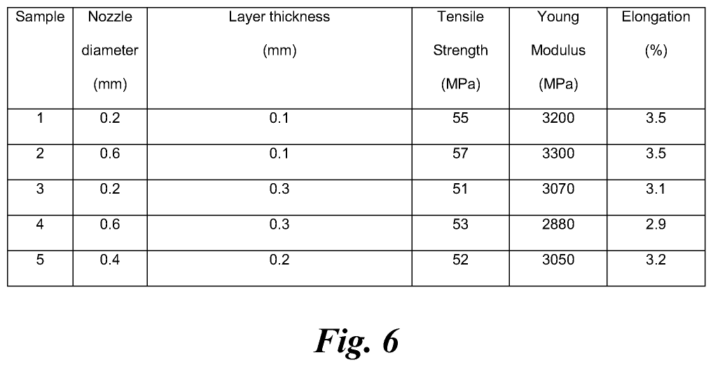

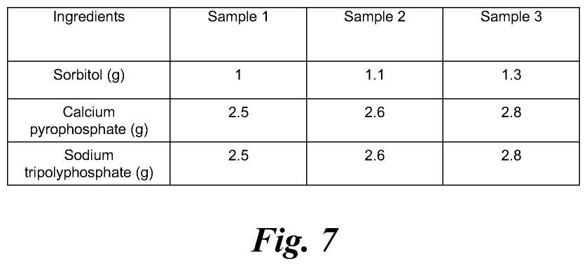

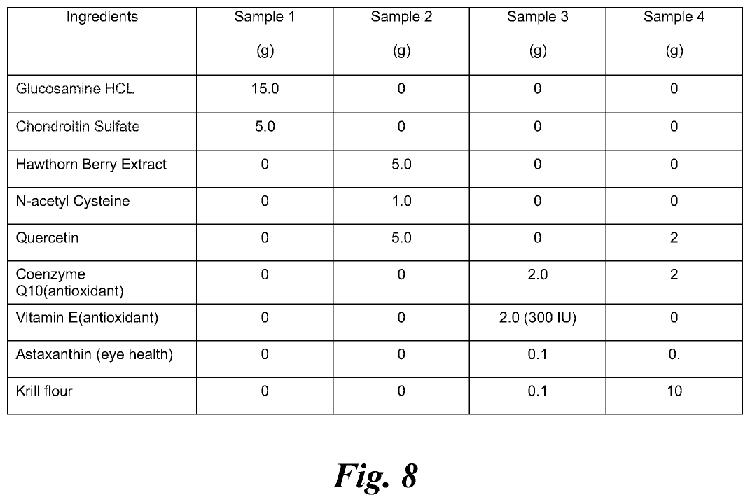

In this example the effect of the 3-D printing conditions on the mechanical properties of the printed article were tested. Filament ingredients were pre-mixed using a high-speed mixer at room temperature using a mixer speed of 2000 rpm. The ingredient quantity is as follows: 100 g of Polylactic acid (PLA4043D, Nature works), 10 g of hemp fiber, 2 g of brewer's yeast, 1 g of calcium stearate, 0.2 g of natural preservatives. Then the mixed ingredients were added to the hopper of an extrusion equipment having different temperatures throughout the barrel. The temperature profile used was 185° C., 195° C., 205° C., 205° C., 195° C., and screw speed was 20 rpm. All filaments were subsequently processed using a 3-D printing machine using the following conditions: Melting temperature: 215° C., Extrusion speed: 25 mm/s, molding speed: 30 mm/s. The final design used for the mechanical properties testing of the printed article were performed according to ASTM D638. The results are shown in FIG. 6.

### EXAMPLE 7

In this example the effect of the inclusion of varied quantities of hygiene and freshener were tested regarding the ease of printing and integrity of a sample 3-D printed bone-shaped dog treat. Filament ingredients were pre-mixed using a high-speed mixer at room temperature using a mixer speed of 2000 rpm. The ingredient quantity is as follows: 100 g of Polylactic acid (PLA4043D, Nature works), 2 g of brewer's yeast, 1 g of calcium stearate, 0.2 g of natural preservatives and other components presented in table 5. Then the mixed ingredients were added to the hopper of an extrusion equipment having different temperatures throughout the barrel. The temperature profile used was 185° C., 195° C., 205° C., 205° C., 195° C., and screw speed was 20 rpm. All filaments were processed using a 3d printing machine using the following conditions: Melting temperature: 215° C., Extrusion speed: 25 mm/s, molding speed: 30 mm/s, orifice size 0.4 and layer thickness 0.2 mm. FIG. 7 presents the quantities in grams of components used in the trials. All trial samples were easily printed into pieces shaped like a dog bone.

### EXAMPLE 8

In this example the effect of the inclusion of varied quantities of nutritional supplements were tested regarding the ease of printing and integrity of a sample 3-D printed bone-shaped dog treat. Filament ingredients were pre-mixed using a high-speed mixer at room temperature using a mixer speed of 2000 rpm. The ingredient quantity is as follows: 100 g of Polylactic acid (PLA4043D, Nature works), 2 g of brewer's yeast, 1 g of calcium stearate, 0.2 g of natural preservatives and other components presented in FIG. 8. Then the mixed ingredients were added to the hopper of an extrusion equipment having different temperatures throughout the barrel. The temperature profile used was 185° C., 195° C., 205° C., 205° C., 195° C., and screw speed was 20 rpm. All filaments were processed using a 3d printing machine using the following conditions: Melting temperature: 215° C., Extrusion speed: 25 mm/s, molding speed: 30 mm/s, orifice size 0.4 and layer thickness 0.2 mm. The samples were easily printed into pieces shaped like a dog bone.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A method of producing a biodegradable article, comprising:
preparing a mixture comprising:
a biodegradable thermoplastic;
a reinforcement agent;
a lubricating agent; and
at least one of a flavoring additive and a nutritional additive;
extruding the mixture to form a filament; and
employing the filament as feedstock for fused filament fabrication of the article.

2. The method according to claim 1, wherein the biodegradable thermoplastic comprises polylactic acid and the article is a chewable pet toy.

3. The method according to claim 2, wherein the biodegradable thermoplastic further comprises at least one plasticizer.

4. The method according to claim 3, wherein the at least one plasticizer is selected from the group consisting of water, glycerol, polypropylene glycol and vegetable oil.

5. The method according to claim 2, wherein the reinforcement agent comprises cellulose fibers.

6. The method according to claim 2, wherein the mixture further comprises an antioxidant stabilizer.

7. The method according to claim 2, wherein the mixture further comprises at least one preservative.

8. The method according to claim 1, wherein the article is an edible pet treat and the biodegradable thermoplastic comprises a mixture of soy protein isolate and a plasticizer.

9. The method according to claim 8, wherein the plasticizer comprises water.

10. The method according to claim 8, wherein the mixture of soy protein isolate and plasticizer comprises 55-60% soy protein isolate and 40-45% water.

11. The method according to claim 8, wherein the plasticizer comprises glycerol.

12. The method according to claim 8, wherein the mixture of soy protein isolate and plasticizer comprises 90-95% soy protein isolate and 5-10% glycerol.

13. The method according to claim 8, wherein the reinforcement agent comprises cellulose nanoparticles.

14. The method according to claim 8, wherein the mixture further comprises at least one preservative.

15. A mixture for extrusion of filament for 3-D printing of biodegradable articles, comprising by weight
40 to 95% of a plasticized biodegradable thermoplastic;
at least 5% of a reinforcement agent;
at least 1% of a lubricating agent; and
at least one of a flavoring additive and a nutritional additive.

16. A mixture for extrusion of filament for 3-D printing of biodegradable articles, comprising by weight:
40 to 95% plasticized biodegradable thermoplastic;
5 to 30% reinforcement agent;
0 to 15% aroma enhancer;
1 to 2% lubricating agent;
0.2 to 1% preservatives; and
up to 15% of at least one of a nutritional additive and a flavoring additive.
